(19) United States
(12) Patent Application Publication
(10) Pub. No.: US 2016/0123466 A1
(43) Pub. Date: May 5, 2016

(54) PISTON RING

(71) Applicant: FEDERAL-MOGUL BURSCHEID GMBH, Burscheid (DE)

(72) Inventor: Thomas SCHULTE-SASSE, Wennelskirchen (DE)

(21) Appl. No.: 14/896,840

(22) PCT Filed: May 10, 2014
(86) PCT No.: PCT/DE2014/000243

§ 371 Date: Dec. 8, 2015

(30) Foreign Application Priority Data
Jun. 8, 2013 (DE) 10 2013 009 645.6

(51) Int. Cl. F16J 9/20

(52) U.S. Cl. CPC F16J 9/20

(57) ABSTRACT

A piston ring is provided in the form of a base body, which has a running face, an inner circumferential surface, and upper flanks and lower flanks interposed therebetween, in which the base body has a joint and an edge relief, in particular in the region of the inner circumferential surface thereof, and wherein the running face, seen in the circumferential direction, is provided with changing running face conicities and/or convexities, such that a lesser running face conicity and/or convexity exists in the region of the joint than in the diametrically opposed ring back.

### BACKGROUND OF THE INVENTION

The invention relates to a piston ring, comprising a base body, which includes a running face, an inner circumferential surface, and upper and lower flanks interposed therebetween, wherein the base body is provided with a joint, and has edge relief in particular in the region of the inner circumferential surface thereof.

EP 1 608 899 B1 discloses a piston ring, comprising a slot forming a joint, a running face, an inner circumferential surface, and upper and lower flanks interposed therebetween, wherein non-constant edge relief is provided in the region of the inner circumferential surface which, seen in the circumferential direction, is designed to be larger in the region of the joint than in the region located diametrically opposite the joint. The piston ring has a wall thickness that varies in the circumferential direction, wherein the wall thickness is designed to be thinner in the region of the joint than in the region located diametrically opposite the joint.

Piston ring edge relief, for example by way of constant or non-constant interior chamfers and/or interior angles, is intended to achieve the technical effect that the piston ring is seated with the lower running face edge against the cylinder wall, and with the inside edge against the lower flank, when the engine is operating.

The solution described in this published prior art is technologically complex and consequently too costly for mass production.

### SUMMARY OF THE INVENTION

It is the object of the invention to provide a piston ring that can be produced more easily compared to the prior art and additionally contributes to lower oil consumption.

This object is achieved by providing the running face, seen in the circumferential direction, with changing running face conicities and/or convexities such that a lesser running face conicity or convexity exists in the region of the joint than on the diametrically opposed ring back.

In piston rings comprising interior chamfers or other geometrically reduced cross-sectional areas, uniform running face conicities or convexities result in non-uniform pivot point positions on the circumference, and consequently in undesirable functional behavior. This may cause hydrodynamic pressure build-up to occur unevenly in local points of the piston ring or, in the severest case, to collapse entirely, whereby effects such as oil from the cylinder wall entering the outlet port region or the like may occur.

Edge relief can be provided both on the inner and on the outer circumferential surface. The geometric shape of the edge relief can be formed by chamfers or angles, referred to generically herein as “chamfers”. A person skilled in the art will select the appropriate type of edge relief for the particular application.

A person skilled in the art of piston rings will understand the term “pivot point” as the radially outermost point (i.e., crest) of convexity/conicity, or the maximum point of the running face profile, or the reversal point of the running face profile when the piston ring is installed. So as to ensure optimal oil scraping behavior, the pivot point should be located at the axially lowest point, based on the respective piston ring. Depending on the design of the running face of a piston ring (conicity, convexity, recess), it is difficult to provide the same pivot point position, throughout the circumference of the pivot ring.

The subject matter of the invention achieves a running face conicity or convexity that is adapted to the twist angle of the respective piston ring, and thus a uniform pivot point position throughout the entire circumference. As described above, the pivot point position decisively controls the functional behavior of a piston ring in the engine. At the same time, the magnitude of the running face conicity has great influence on the sealing behavior under gas pressure during engine operation.

The subject matter of the invention drastically minimizes the gas attack surface on the running face, whereby, based on the circumference of the piston ring, optimization of the necessary conicities is provided.

It is particularly advantageous that the changing running face conicities can be set as a function of the geometric shape of the edge relief of the piston ring.

Proceeding from the joint, the running face conicities increase in a constant or non-constant manner in the two circumferential directions. This will depend on the use of the piston ring.

The subject matter of the invention is shown in the drawing based on an exemplary embodiment and is described as follows.

### BRIEF DESCRIPTION OF THE DRAWINGS

In the drawings:

FIGS. 1A, 1B and 2A, 2B show exemplary representations of the prior art; and

FIG. 3 shows schematic diagrams of a cross-section of a piston ring according to the invention.

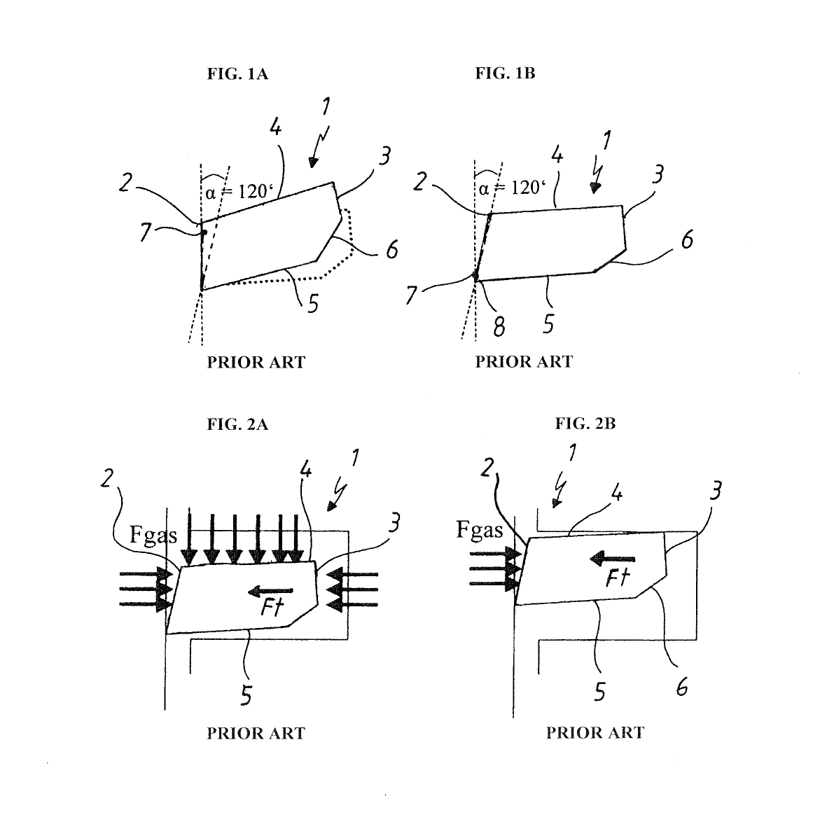

FIGS. 1A, 1B and 2A, 2B show practical examples of the current state of the art. A piston ring 1 is shown, which comprises a running face 2, an inner circumferential surface 3, and upper and lower flanks 4, 5 interposed therebetween. The joint of the piston ring 1 is not shown, FIG. 1 of EP 1 808 899 B1 is incorporated herein, in which the joint of the piston ring can be seen. The piston ring 1 shown in FIGS. 1A, 1B and 2A, 2B comprises edge relief 8 in the form of an interior chamfer. This edge relief 8 causes the piston ring 1 to twist in the circumferential direction. Since the piston ring 1 is not closed, but rather has a joint, the twist angle changes in the circumferential direction.

FIGS. 1A, 1B show that the pivot point 7, looking at the circumference, changes for an assumed twist angle α of 120′ (i.e., 120 arcminutes). The pivot point 7 would be located in the ring back region above the center of the piston ring 1 (FIG. 1A) and in the region of the ring joint approximately in the region of the scraping edge 8 (FIG. 1B).

FIGS. 2A, 2B show the influence of the gas pressure (Fgas) on a piston ring shown in FIGS. 1A, 1B. A balanced state across the entire circumference of the piston ring 1 is theoretically assumed to exist in in FIG. 2A. During practical use, however, the gas pressure (Fgas) is greater, looking at the circumference of the piston ring 1, than the radial tension force (Ft) of the piston ring 1 opposing the same.

As was already described, uniform running face conicities or convexities, looking at the circumference, result in non-uniform pivot point positions 7 in piston rings 1 having reduced cross-sectional areas, and consequently in undesirable unstable functional behavior. This may cause hydrodynamic pressure build-up to occur unevenly in local points of the piston ring circumference, whereby effects such as oil from the cylinder wall entering the outlet port region or the like may occur.

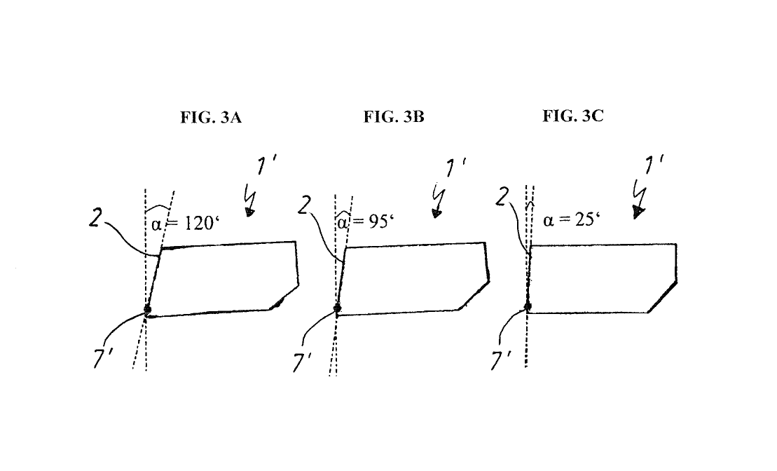

FIGS. 3A, 3B, 3C show the subject matter of the invention. So as to achieve a consistently uniform pivot point position 7′, looking at the circumference of the piston ring 1′, the running face 2 of the piston ring 1′ is provided with changing running face conicities α in the circumferential direction, such that, a lesser running face conicity α exists in the region of the joint, which is not shown, (FIG. 3C) than in the diametrically opposed ring back region (FIG. 3A). Proceeding from FIG. 3C in the direction of the ring back (FIG. 3A), the running face conicity α can change in a constant or non-constant manner. FIGS. 3A, 3B, 3C show that the running face conicity α changes constantly, which is to say continuously, from the ring joint (FIG. 3C) in the direction of the ring back (FIG. 3A). FIG. 3B showing a piston on the circumference of the ring intermediate the ring joint and the ring back. As differs from the prior art, the running face conicities α of the running face 2 are thus set to be much larger, looking at the circumference, than the maximum twist angle. As a result of running face conicities α or convexities that are adapted to the twist angle, a uniform pivot point position 7 is achieved, based on the circumference of the piston ring 1′. The pivot point position 7′ decisively controls the functional behavior of the piston ring 1′ in the engine. At the same time, the magnitude of the running face conicity α has great influence on the sealing behavior under gas pressure during engine operation. The subject matter of the invention drastically minimizes the gas attack surface on the running face 2, whereby, based on the total circumference of the piston ring 1′, optimization of the necessary running face conicity is achieved.

1. A piston ring, comprising a base body, the base body having a running face, an inner circumferential surface, an upper flank and a lower flank interposed between the running face and the inner circumferential surface, the base body being provided with a joint and having edge relief in a region of the inner circumferential surface, wherein the running face is provided with conicity (α) or convexity which varies along the circumference of the ring and is greater in a region of the joint than at a diametrically opposed ring back.

2. The piston ring according to claim 1, wherein the varying running face conicity or convexity is configured as a function of the geometric shape of the edge relief.

3. The piston ring according to claim 1, wherein the edge relief is a chamfer.

4. (canceled)

5. The piston ring according to claim 1, wherein in both circumferential directions beginning at the joint the conicity or convexity constantly increases to a maximum at a position on the ring diametrically opposed to the joint.

6. The piston ring according to claim 1, wherein in both circumferential directions beginning at the joint the conicity or convexity non-constantly increases to a maximum at a position on the ring diametrically opposed to the joint.
